(19) United States
(12) Patent Application Publication
(10) Pub. No.: US 2014/0288996 A1
(43) Pub. Date: Sep. 25, 2014

(54) TECHNOLOGY ASSET TRACKING SYSTEM AND METHOD

(71) Applicant: Digital River, Inc., Minnetonka, MN (US)

(72) Inventors: Christopher Joseph RENCE, Balsam Lake, WI (US); Mary Suddendorf Braunwarth, Waconia, MN (US)

(73) Assignee: Digital River, Inc., Minnetonka, MN (US)

(21) Appl. No.: 14/213,208

(22) Filed: Mar. 14, 2014

Related U.S. Application Data
(60) Provisional application No. 61/782,472, filed on Mar. 14, 2013.

(51) Int. Cl. G06Q 10/06

(52) U.S. Cl. CPC G06Q 10/0635
USPC 705/7.28

(57) ABSTRACT

A Technology Asset Tracking System and Method tracks all technology assets including software, hardware and other devices and telecommunications equipment, plans, contracts and agreements, and usage of technology assets from acquisition and assignment to disposal/retirement. An asset database maintains details on each of the devices, including its costs and features. Business rules related to device usage, including compliance policies, are maintained and checked against phone usage to monitor compliance. The system is designed to provide enterprise level configuration and compliance management—to accumulate information about configurations, changes and other data from disparate sources and enable management and data providers to integrate their data into a coherent, seamless unit, using a familiar type of interface.

### RELATED APPLICATIONS

This application claims the benefit of U.S. Provisional Application No. 61/782,472 filed Mar. 14, 2013, entitled “Technology Asset Tracking System and Method,” which is incorporated herein by reference.

### FIELD OF THE INVENTION

The field of invention relates generally to management of information technology resources.

### BACKGROUND OF THE INVENTION

The number and type of devices companies employ to do business nowadays presents several challenges for an organization's technology and security managers. Each employee and contractor typically has at least a laptop or PC, maybe both, in addition to a cell phone and tablet computer or other mobile device. In addition, employees may also bring their own device to work. These devices allow an employee to work from anywhere with internet or telecommunications access. However, these many and varied devices may be difficult to manage, create security and compliance risks and increase a company's risk profile due to data loss or abuse.

Various systems have been developed to assist technology managers in managing a company's devices. These systems may include an IT Service Management (ITSM) component and a configuration management database (CMDB) component. An ITSM component facilitates the process of managing technology services and assets, including software and hardware. The CMDB stores the data regarding all of the various devices and software in an organization's technology infrastructure and allows managers to manage and track changes throughout that infrastructure. The implementation of such a system may involve significant investment.

Technology managers are challenged by the vast number and type of devices, plans and software used by their employees. There is a proliferation of mobile devices, plans, and spend to track on a global basis. Limited oversight of employee-owned devices (e.g. BYOD), limited knowledge of corporate IP exposure, limited knowledge of corporate spend on applications, tools or services all add another level of business risk to manage with limited time and resources. In addition, organizations are exposed if a unit is lost or stolen and have limited knowledge with which to react. Currently, nothing exists that provides these functions and features for technology assets.

Technology managers, particularly those in small to medium sized businesses, require a way to store and manage their physical and software technology assets without having to make a huge investment in monitoring software and technology. The various embodiments described herein offer a solution to those and other problems recognized in the art.

### BRIEF SUMMARY

A service support management application and service to support a company's use of information and communications technology is described. The application ties together several technologies for a new and useful tool that may be used on a subscription or licensed basis. A preferred embodiment uses cloud technology, tracks all technology assets including software, hardware and other devices, and telecommunications equipment, plans and usage through acquisition and assignment to disposal/retirement.

In one embodiment, an information and communications technology asset tracking system may comprise An information and communications technology asset tracking system stored in non-transitory memory, comprising: a database structure stored memory comprising records describing (i) technology assets; (ii) the identification and properties of each asset, (iii) business rules and restrictions related to tracking assets; a compliance module operatively configured to monitor the usage of assets for compliance with business rules; and a reporting and analytics module operatively configured to provide alerts and scheduled or on demand reports on at least: (i) cost management, (ii) configuration management and (iii) change management for each asset tracked.

In another embodiment, an information and communications technology asset tracking system may comprise the modules described above and in addition, further comprise a user interface module or a bulk loading module for performing bulk upload of asset listings and details, a billing system module operatively configured to measure subscription parameters and bill a user for use of the system and a security system module API set allowing data to be filtered their service appliance or services to track malware and unauthorized content delivery.

Other embodiments may include tracking usage and compliance for telecommunications equipment by inputting data and analyzing it against a set of business rules and reporting on the result.

### BRIEF DESCRIPTION OF THE DRAWINGS

FIG. 1 illustrates a Technology Asset Tracking System and Method in context.

FIG. 2 illustrates an exemplary technology asset tracking system.

FIG. 3 illustrates an exemplary e-commerce subscription billing architecture.

FIG. 4 illustrates the business and IT organizational ecosystem served by a Technology Asset Tracking System and Method.

### DETAILED DESCRIPTION

An application and service to support a company's use of information and communications technology is described. The application ties together several technologies for a new and useful system that may leverage cloud technology and may be used on a subscription or licensed basis. Such a system provides infrastructure visibility to monitor assets in real time and can identify potential issues related to computing devices, software and telecommunications devices and systems prior to change deployment. In addition, the system allows integration of monitoring data with compliance and cost management support to facilitate company-wide technology and telecommunications planning, strategy and implementation.

The system and method is designed to provide enterprise level configuration and compliance management—to accumulate information about configurations, changes and other data from disparate sources. One goal is to enable management data providers to integrate their data into a coherent, seamless unit, using a familiar type of interface.

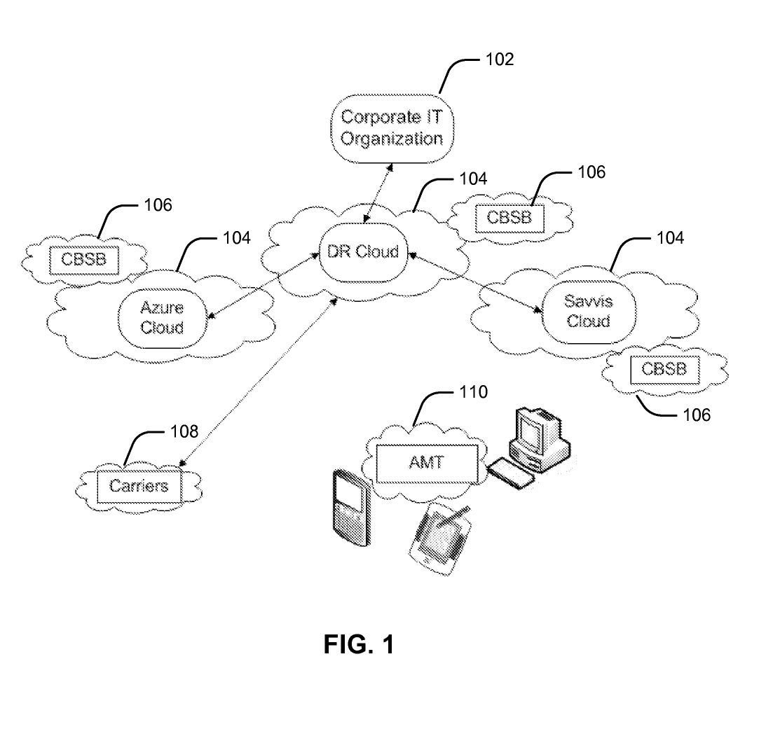

FIG. 1 illustrates an exemplary information and communications technology asset tracking system. In one embodiment of an information technology asset tracking system, cloud technology is leveraged to create a subscription-based service for managing information technology assets. The host cloud 104 comprises at least an asset tracking database, similar to a configuration management database, a file upload module, an asset tracking user interface and reporting module. Subscribers may access the system using a set of standard application programming interfaces from an online application, a mobile app or through web services. A cloud-based subscription billing module (CBSB) 106 tracks system usage by subscribers.

Referring again to FIG. 1, a simple embodiment of the various components of the asset tracking system is illustrated, which may be hosted in a distributed manner in a cloud environment. The diagram illustrates a corporate IT organization 102 accessing a technology asset tracking system from various host cloud systems 104, each associated with a cloud-based subscription billing system 106. While the system is described here in terms of an embodiment in which an organization accesses a cloud-based system on a subscription basis, the system may also be offered in other ways, such as installed on a server and licensed on a per unit time (monthly, annually, etc) basis. Subscription billing offers advantages to the corporate IT organization to save money by only using services it needs when it needs them. Carrier 108 data, including billing and device information, may be loaded into the system to track costs. Finally, the Asset Management Tracking 110, or Technology Asset Tracking, system provides the interface which allows the technology manager to monitor technology assets and technology and telecommunications planning, strategy and implementation.

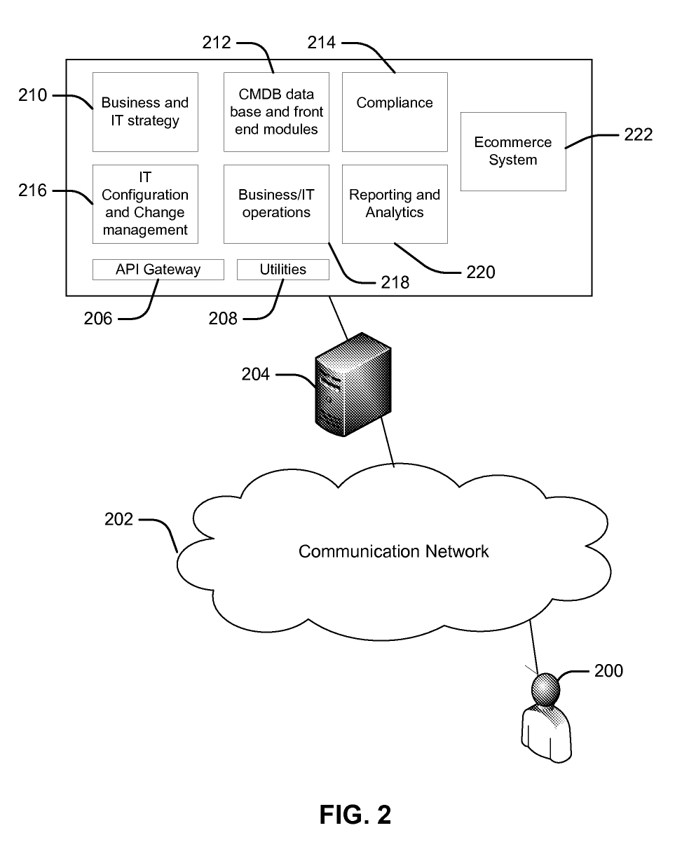

In one embodiment, the system comprises a number of features and modules as further illustrated in FIG. 2. This illustration shows a user 202 accessing the system through a communication network 204, such as the internet, in order to maintain, report, analyze or otherwise take advantage of the features of the system. The system may be accessed through a set of standard APIs 206 that allow the user to update, maintain, retrieve, analyze or otherwise manipulate data in the system. The user may alternatively use a set of utilities provided, including bulk loading of data 208. Various modules may provide the features available to the system. While these features are described as being embodied in certain “modules” the features may be distributed in any number of ways. The diagram in FIG. 2 illustrates one way of modularizing the features, but other ways are possible as well. A business and IT strategy module 210 allows the technology manager to maintain business rules and restrictions (particularly for compliance with company policies), regarding usage and distribution of technology assets. A Configuration Management Data Base and front end module 212 provides storage of records related to the technology assets, including an identification of the asset, an assignment or location of the asset, the features activated on the asset, software or applications included, usage details, and more. A compliance module 214 monitors the usage of the phone against company policies and may automatically generate a block, or an alert, on a device where violations are discovered.

A set of standard APIs 208 allow subscribers to access the asset management tracking system. An application programming interface (API) is the specific method prescribed by a computer operating system or by an application program by which a programmer writing an application program can make requests of the operating system or another application. An API is a set of functions, procedures, methods or classes used by computer programs to request services from the operating system, software libraries or any other service providers running on a computer. Several types of APIs may be included in order to transmit data and information among modules and to and from other systems and users. For example, web services APIs may be used to purchase software from an e-commerce provider via the purchasing module. Additionally, various APIs may be provided for accessing the data and functionality of the asset management tracking system from the user interface.

Security system interface protocols can be managed through a set of API allowing data routing to be screened by standard security tools, applications or service interfaces, and allowing the identification of malware, unauthorized data downloads, software downloads or transfer or bulk data.

IT configuration and change management 216 and Business/IT operations 218 allows management to make changes to both technology and policy. Configuration management tracks software licenses and applications, software licenses, service agreements, hardware leases and maintenance contracts. Additional operations include: incident management/service desk; operations management, problem management; service planning, service level management, business assessment, IT strategy development, customer management and any other features and operations related to the management and tracking of technology assets. Also included may be a reporting and analytics module 220 which allows the manager to perform cost management, equipment monitoring and tracking, and financial and other analyses. A reporting module provides the IT manager with comprehensive insight into the number of devices the company owns or leases, whom the devices are assigned to, the software or applications on each, the software and applications allowed for each, what kind of activity is taking place on the device, what kind of errors or problems the device is experiencing, etc. The system further includes an ecommerce system module 222, primarily for subscription based billing, which will be described in more detail later.

The asset management interface and APIs 206 provide access to services and tools supporting reporting, change requests, capacity planning, compliance assurance, problem management operations management incident management service desk, release to production/build and test, monitoring, planning modules (service, operations, customer management, change management), and cost management, among others. Services included span the areas of Business-IT alignment, and operations which allows business to align their IT strategy with business strategy.

The system provides IT managers with the ability to track device (hardware such as personal computers, tablets, telecommunications devices, printers, etc) and financial assets such as software licenses, service agreements, hardware leases and maintenance contracts. Managers can align IT assets to financial assets and optimize assets through impact analysis, gap discovery, risk management, and cost reduction. This system allows the manager to manage costs in real time.

An asset tracking management data base, or configuration management data base 212, is a repository of information related to all the components of an information system. It contains the details of the configuration items in the IT infrastructure. Although repositories similar to this have been used by IT departments for many years, this database represents the configuration of the significant components of the IT environment as well as rules for monitoring and maintaining compliance with company policies and cost management. The system and services help an organization understand the relationships between these components and track their configuration. A key success factor in implementing such a system is the ability to automatically discover information about the assets and resources and track changes as they happen.

An asset management tracking system and method comprises, in part, a database module to record and maintain data related to physical and digital assets. Assets may be owned by the managing organization or by a third party. Assets are tracked and managed over the entire period of possession by the organization, from acquisition and assignment to a user, through ongoing usage and disposal or retirement. A database, similar to a configuration database is used to store and maintain records and controls related to physical and digital technology assets. The database may track identifying information related to the asset, associated relationships, usage data, applicable business rules and other dependencies, disposal/retirement and more.

Assets may be input into the database using a user interface, API or uploaded from a carriers feeds (FTP, API or XML) to capture technology upgrades, Application updates or changes. Technology managers may import or otherwise input data identifying all of the cell phones, tablets or personal digital assistants assigned to employees of the organization. Subsequently, the technology manager may import monthly usage data, including carrier data such as call transactions, app downloads, pay by text transactions, etc. This data may be used in several modules, including cost management, compliance and reporting.

In addition, the database module 212 provides data to additional modules, such as the reporting and analytics module 220, that allow the managing organization to perform business analysis related to those assets. Asset management interfaces allow the user, internal modules and external systems and modules to access the database and information in the database. Interfaces may be standard APIs 206 or graphical user interfaces, scheduled or on-demand reporting, data extracts or data feeds 208.

Compliance is an important issue in many organizations. For example, many company policies forbid downloading of questionable content to employee computing devices or telecommunications equipment, or accessing certain telephone numbers. The system can block the unwanted or restricted applications, report what software is on a phone or device, prevent unauthorized text messages, or block the use of particular phone numbers. The asset management database maintains records of all of the features, applications and content on each device and a compliance module determines compliance with company policies and procedures.

A compliance module 218 provides rules and restrictions regarding employee access to applications, data and features. For example, companies may want to blacklist particular applications or prevent or restrict download to company owned or issued devices. By monitoring reports or getting alerts, technology managers can discover blacklisted apps on a device, and may take action to remove the app or revoke the device from its assigned user. Similarly, monitoring usage allows the manager to discover pay by text transactions and access to features not supported by the organization's telecommunication policy. With this information the manager may take appropriate action to remove the app, charge the employee, revoke possession of the device, or take similar action. In addition, the compliance module 218 and reporting and analytics module 220 may report deviations from policy or compliance violations to management, either through on-demand reporting, automated alerts, or automated reporting based on a set of thresholds.

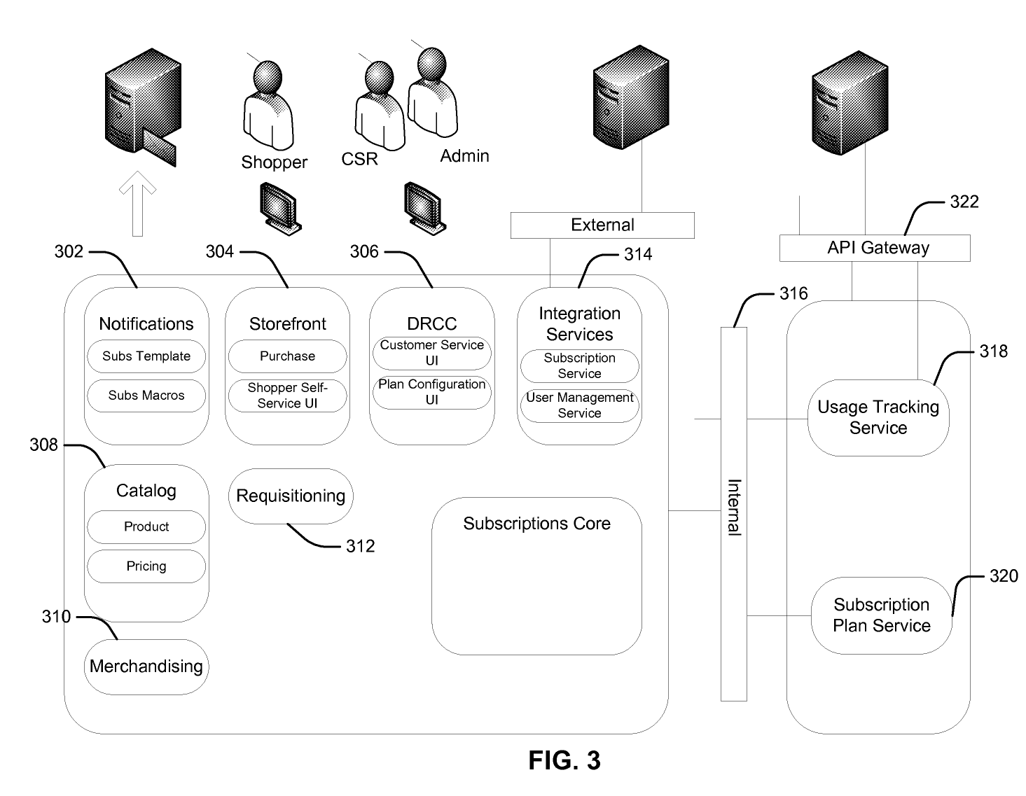

Cloud-based subscription billing offers a system and method for making usage-based billings similar to a telephone bill and also allows the provision of localized content. FIG. 3 illustrates an exemplary subscription billing architecture within an e-commerce system. Such a system typically includes notifications (such as email notifications) 302, storefront features 304, customer service and subscription plans 306, catalog and pricing features 308, merchandising 310, requisitioning 312 and integration services 314. Internal APIs 316 interact with usage tracking 318 and subscription plan services 320 which may be retrieved through subscription tracking services API gateway 322.

A purchasing/billing module may be included to facilitate subscription based payments for leasing the application, and/or purchase of software and content from an e-commerce provider. This module may use APIs provided by the e-commerce provider in order to access catalog and shopping cart functionality, as well as to a subscription-based billing module which would be used to track usage and charge the manager when leasing the system. Including micro transaction and hierarchy management allowing a controlled usage and spend across any device type linked onto a corporations network.

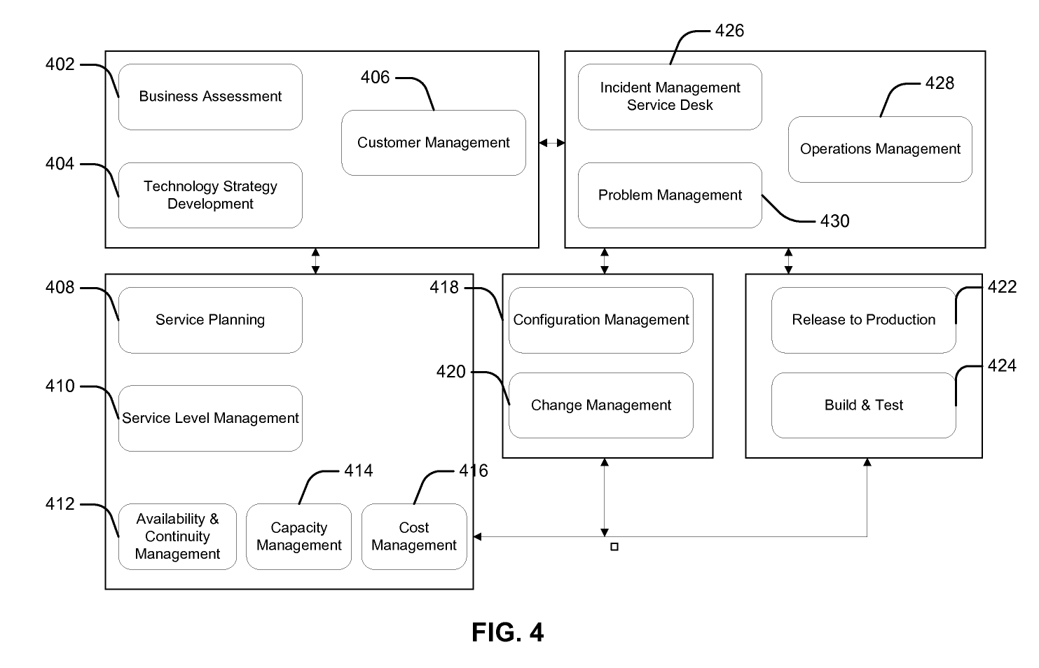

FIG. 4 is a simplified illustration of the ecosystem of business and IT functions that are both drawn on and served by a technology asset tracking system. The asset management system provides a large number of services for those managing these assets. By way of example and not limitation, services provided by the asset management system include direct management functions, such as assignment of devices to employees, telecommunication device usage tracking, assignment of software to individual computing devices, compliance implementation (including blocking noncompliant downloads to devices). Additionally, data is provided as input to interrelated services such as business strategy services (such as Business Assessment 402, Technology Strategy Development 404 and Customer management 406), IT services (service planning 408, service level management 410, availability & continuity management 412, capacity management 414, cost management 416), IT configuration and deployment (configuration management 418, change management 420, release to production 422 and build and test 424), and operations (incident management service desk 426, operations management 428, problem management 430).

Local computers and servers in this environment have general characteristics and are necessarily composed of a number of electronic components. The ecommerce environment in which an asset management tracking system and method operates is necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules generally consist of instructions stored in memory for execution by a processor. The various components of an ecommerce service provider, the ecommerce application, comprises application interfaces, a commerce engine, services, third party services and solutions and client and partner integrations. The application interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, users may access the ecommerce application suite from a computer workstation or server, a desktop or laptop computer, or a mobile device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Client integrations may be comprised of client external systems (customer relationship management, financials, etc), sales feeds and reports and catalog and product feeds. Partner integrations may include fulfillment partners, client fulfillment systems, and warehouse and logistics providers.

An electronic computing device, such as a laptop, tablet computer, smartphone, or other mobile computing device typically includes, among other things, a processor (central processing unit, or CPU), non-transitory memory, a graphics chip, a secondary storage device, input and output devices, and possibly a display device, all of which may be interconnected using a system bus. Input and output may be manual performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

A secondary storage device may include a hard disk drive, floppy disk drive, CD-ROM drive, DVD-ROM drive, or other types of non-volatile data storage, and may correspond with the various equipment and modules shown in the figures. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer, computing device or server has been described with various components, it should be noted that such a computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be client or server computers. Client computers and devices (e.g.) are those used by end users to access information from a server over a network, such as the Internet. These devices can be a desktop or laptop computer, a standalone desktop, or any other type of computing device. Servers are understood to be those computing devices that provide services to other machines, and can be (but are not required to be) dedicated to hosting applications or content to be accessed by any number of client computers. Web servers, application servers and data storage servers may be hosted on the same or different machines. They may be located together or be distributed across locations. Operations may be performed from a single computing device or distributed across geographically or logically diverse locations.

In a preferred embodiment, the asset management tracking system and method derives much of its benefits by leveraging network and cloud technologies. Client computers access features of the system described herein using Web Services. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An information and communications technology asset tracking system stored in non-transitory memory, comprising:
a database structure stored memory comprising records describing (i) technology assets;
(ii) the identification and properties of each asset, (iii) business rules and restrictions related to tracking assets;
a compliance module operatively configured to monitor the usage of assets for compliance with business rules; and
a reporting and analytics module operatively configured to provide alerts and scheduled or on demand reports on at least: (i) cost management, (ii) configuration management and (iii) change management for each asset tracked;

2. The information and communications technology asset tracking system of claim 1 further comprising:
a billing system module operatively configured to measure subscription parameters and bill a user for use of the system.

3. The information and communications technology asset tracking system of claim 2 further comprising:
a security system module API set allowing data to be filtered their service appliance or services to track malware and unauthorized content delivery.

4. The information and communications technology asset tracking system of claim 1 further comprising a user interface module.

5. The information and communications technology asset tracking system of claim 1 further comprising a bulk loading module for performing bulk upload of asset listings.
